(19) United States
(12) Patent Application Publication
(10) Pub. No.: US 2026/0188549 A1
(43) Pub. Date: Jul. 2, 2026

(54) SYSTEMS AND METHODS FOR SPRING CLAMP CORE STACKING

(71) Applicant: UCHICAGO ARGONNE, LLC, Chicago, IL (US)

(72) Inventor: Mark S. JASKI, Palos Park, IL (US)

(73) Assignee: UCHICAGO ARGONNE, LLC, Chicago, IL (US)

(21) Appl. No.: 19/368,596

(22) Filed: Oct. 24, 2025

Related U.S. Application Data
(60) Provisional application No. 63/739,045, filed on Dec. 26, 2024.

(51) Int. Cl. H01F 3/02; H01F 7/06; H01F 41/02

(52) U.S. Cl. CPC H01F 3/02; H01F 7/06; H01F 41/0233

(57) ABSTRACT

An assembly can include a magnet segment. The magnet segment can include a lamination stack. The lamination stack can include a plurality of laminations arranged in a stacked configuration. Each of the plurality of laminations can include a first arm spring, a first reference surface, a first spring clamp that includes a second reference surface and a third reference surface, a second arm spring, a fourth reference surface, and a second spring clamp that includes a fifth reference surface and a sixth reference surface. The magnet segment can include a first side plate, a second side plate, a first end plate, and a second end plate.

### CROSS-REFERENCE TO RELATED APPLICATION

This application claims priority to U.S. Provisional Patent App. No. 63/739,045, filed Dec. 26, 2024, the contents of which is incorporated herein by reference in its entirety.

### STATEMENT OF GOVERNMENT INTEREST

This invention was made with government support under Contract No. DE-AC02-06CH11357 awarded by the United States Department of Energy to UChicago Argonne, LLC, operator of Argonne National Laboratory. The government has certain rights in the invention.

### TECHNICAL FIELD

The present disclosure relates generally to electromagnets.

### BACKGROUND

Room temperature electromagnets can be used for accelerators.

### SUMMARY

One aspect of the present disclosure is directed to an assembly. The assembly can include a magnet segment. The magnet segment can include a lamination stack. The lamination stack can include a plurality of laminations arranged in a stacked configuration. Each of the plurality of laminations can include a first portion of a first end of the lamination. The first portion of the first end of the lamination can include a first arm spring. The first portion of the first end of the lamination can include a first reference surface positioned a first distance from the first arm spring. The first portion of the first end of the lamination can include a first spring clamp base positioned a second distance from the first arm spring. The first spring clamp base can include a second reference surface and a third reference surface. Each of the plurality of laminations can include a second portion of the first end of the lamination. The second portion of the first end of the lamination can include a second arm spring. The second portion of the first end of the lamination can include a fourth reference surface positioned a third distance from the second arm spring. The second portion of the first end of the lamination can include a second spring clamp base positioned a fourth distance from the second arm spring. The second spring clamp base can include a fifth reference surface and a sixth reference surface. Each of the plurality of laminations can include a second end of the lamination. The second ends of the plurality of laminations can form a pole tip. The magnet segment can include a first side plate configured to couple with the first portions of the first ends of the plurality of laminations. The magnet segment can include a second side plate configured to couple with the second portion of the first ends of the plurality of laminations. The magnet segment can include a first end plate positioned at a first end of the lamination stack. The magnet segment can include a second end plate positioned at a second end of the lamination stack.

Another aspect of the present disclosure is directed to a method. The method can include providing a lamination stack. The lamination stack can include a plurality of laminations arranged in a stacked configuration. Each of the plurality of laminations can include a first portion of a first end of the lamination. The first portion of the first end of the lamination can include a first arm spring. The first portion of the first end of the lamination can include a first reference surface positioned a first distance from the first arm spring. The first portion of the first end of the lamination can include a first spring clamp base positioned a second distance from the first arm spring. The first spring clamp base can include a second reference surface and a third reference surface. Each of the plurality of laminations can include a second portion of the first end of the lamination. The second portion of the first end of the lamination can include a second arm spring. The second portion of the first end of the lamination can include a fourth reference surface positioned a third distance from the second arm spring. The second portion of the first end of the lamination can include a second spring clamp base positioned a fourth distance from the second arm spring. The second spring clamp base can include a fifth reference surface and a sixth reference surface. A second end of the plurality of laminations can form a pole tip. The method can include coupling a first side plate with the first portions of the first ends of the plurality of laminations. The method can include coupling a second side plate with the second portion of the first ends of the plurality of laminations. The method can include coupling a first end plate with a first end of the lamination stack. The method can include coupling a second end plate with a second end of the lamination stack.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF DRAWINGS

The foregoing and other features of the present disclosure will become more fully apparent from the following description and appended claims, taken in conjunction with the accompanying drawings. Understanding that these drawings depict only several implementations in accordance with the disclosure and are, therefore, not to be considered limiting of its scope, the disclosure will be described with additional specificity and detail through the use of the accompanying drawings.

FIG. 1A illustrates a schematic diagram of a magnet assembly, according to an example implementation.

FIG. 1B illustrates a schematic diagram of magnet assemblies, according to an example implementation.

FIG. 2 illustrates a schematic diagram of the magnet assembly, according to an example implementation.

FIG. 3 illustrates a schematic diagram of a magnet segment, according to an example implementation.

FIG. 4 illustrates a schematic diagram of a lamination, according to an example implementation.

FIGS. 5A and 5B illustrate schematic diagrams of the laminations, according to an example implementation.

FIG. 6 illustrates a diagram of a portion of the magnet segment, according to an example implementation.

FIG. 7 illustrates a schematic diagram of a portion of the magnet assembly, according to an example implementation.

FIG. 8 illustrates a schematic diagram of a portion of the magnet assembly, according to an example implementation.

FIG. 9 illustrates a schematic diagram of the magnet assembly, according to an example implementation.

FIG. 10 illustrates a schematic diagram of the magnet assembly, according to an example implementation.

FIG. 11 illustrates a schematic diagram of a portion of the magnet assembly, according to an example implementation.

FIG. 12 illustrates a schematic diagram of a portion of the magnet assembly, according to an example implementation.

FIG. 13 illustrates a schematic diagram of a portion of the magnet assembly, according to an example implementation.

FIG. 14 illustrates a schematic diagram of a portion of the magnet assembly, according to an example implementation.

FIG. 15 illustrates a schematic diagram of the lamination, according to an example implementation.

FIG. 16 illustrates a schematic diagram of a portion of the magnet assembly, according to an example implementation.

FIG. 17 illustrates a schematic diagram of the magnet segment, according to an example implementation.

FIG. 18 illustrates a schematic diagram of a portion of the magnet assembly, according to an example implementation.

FIG. 19 illustrates a schematic diagram of the magnet assembly, according to an example implementation.

FIG. 20 illustrates a schematic diagram of the magnet assembly, according to an example implementation.

FIG. 21 illustrates a schematic diagram of the magnet assembly, according to an example implementation.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Following below are more detailed descriptions of various concepts related to, and implementations of, methods, apparatuses, and systems for spring clamp core stacking. The various concepts introduced above and discussed in greater detail below may be implemented in any of numerous ways.

Room temperature electromagnets can be used in the storage ring accelerator science community. Hundreds to thousands of electromagnets can be used to build an accelerator. These electromagnets can include, but not limited to, dipoles, quadrupoles, sextupoles, octupoles, and correctors. Accelerator electromagnets can be made of laminated magnet cores. Solid core magnets can be used for non-transient magnetic fields but can be expensive and time-consuming to machine, thereby increasing the cost over laminated cores. Laminated cores must be used if the magnetic field is transient.

To create the high-quality magnetic fields needed to operate these accelerators, magnet core pole tips should be precisely shaped and positioned in accelerator magnets. Magnet cores can be made with stacked laminations which are glued with epoxy, welded, or both. Welding and/or gluing laminations may not be precise and may undergo secondary machining to achieve the precision needed for a magnet to produce a high-quality magnetic field. The high-quality magnetic field can be quantified according to an error of multipoles. This can add cost and complexity to the manufacturing process.

The systems and methods of the present disclosure can allow for accurately positioned poles, and thus, accurate magnetic fields (e.g., small, within tolerance, multipole errors compared to the main field). The accurate and/or high quality magnetic field can be produced by multipoles having an error of less than the tolerance specified by the lattice designers. The tolerance can be in a range of 0.001 to 0.0001 of the main field for x-ray producing accelerator magnets. The spring clamp method can use mechanical clamping to accurately position laminations for magnet cores, thus avoiding the inaccuracies of welding and gluing. The spring clamp method can be implemented using mechanical assembly which opens the opportunity for many more machine shop vendors to be able to precisely assemble magnet cores. Using the spring clamp method can lower cost and delivery times to manufacture accelerator cores because it does not require the skills and tools of a welder and/or gluer.

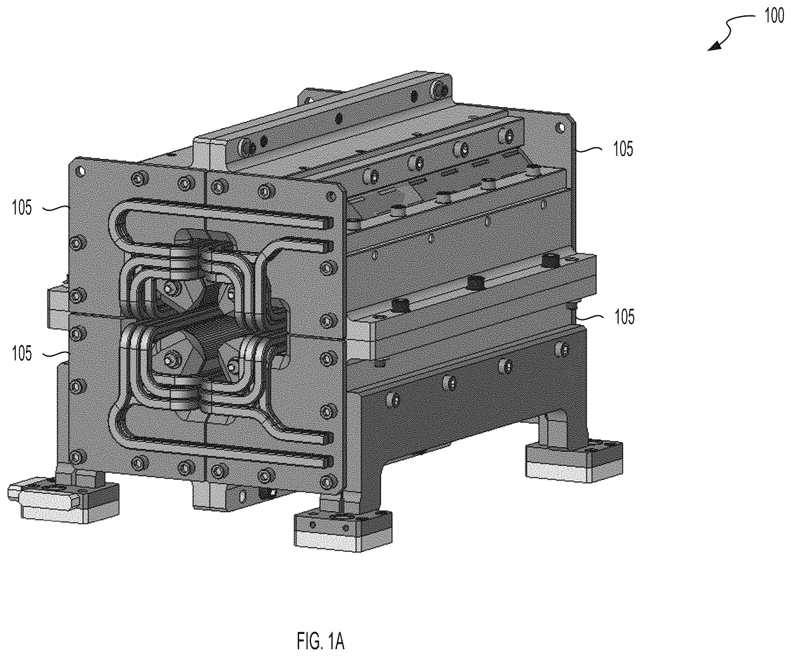

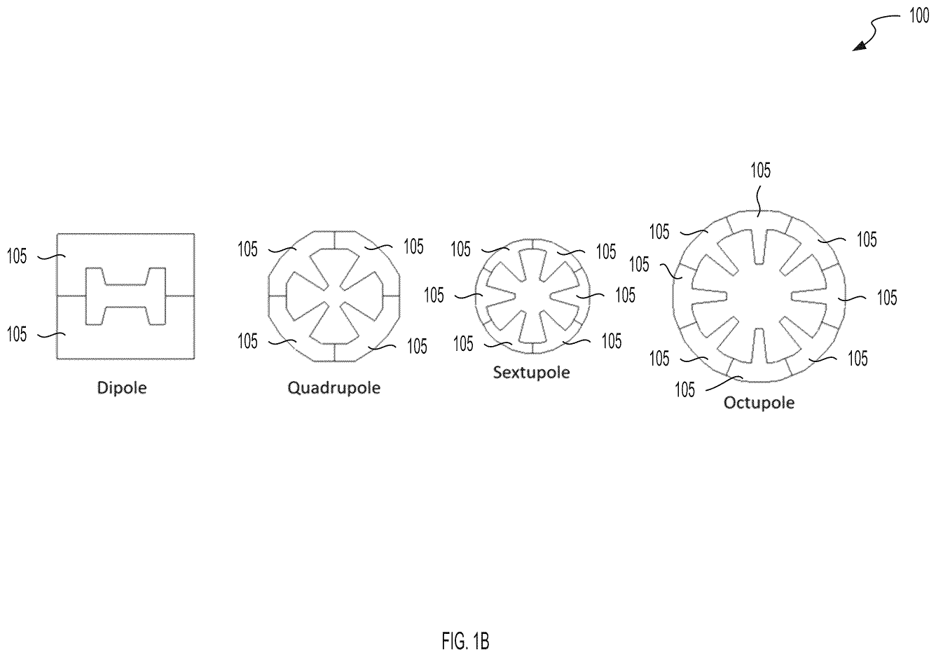

FIG. 1A illustrates a schematic diagram of an assembly 100 (e.g., system, magnet assembly, magnet system). The assembly 100 can include two or more magnet segments 105. For example, the assembly 100 can include two magnet segments 105 to form a dipole magnet. The assembly 100 can include four magnet segments 105 to form a quadrupole magnet. The assembly 100 can include six magnet segments 105 to form a sextupole magnet. The assembly 100 can include eight magnet segments 105 to form an octupole magnet. The assembly 100 can include a plurality of magnet segments 105 to form a corrector magnet. The two or more magnet segments 105 can include a first magnet segment 105, a second magnet segment 105, a third magnet segment 105, and a fourth magnet segment 105. The first magnet segment 105 can be coupled with the second magnet segment 105 and the fourth magnet segment 105. The second magnet segment 105 can be coupled with the third magnet segment 105 and the first magnet segment 105. The third magnet segment 105 can be coupled with the fourth magnet segment 105 and the second magnet segment 105. The fourth magnet segment 105 can be coupled with the first magnet segment 105 and the third magnet segment 105.

FIG. 1B illustrates a schematic diagram of assemblies 100. The assembly 100 can include a dipole magnet (e.g., dipole). The dipole can include two magnet segments 105. The assembly 100 can include a quadrupole magnet (e.g., quadrupole). The quadrupole can include four magnet segments 105. The assembly 100 can include a sextupole magnet (e.g., sextupole). The sextupole can include six magnet segments 105. The assembly can include an octupole magnet (e.g., octupole). The octupole can include eight magnet segments 105.

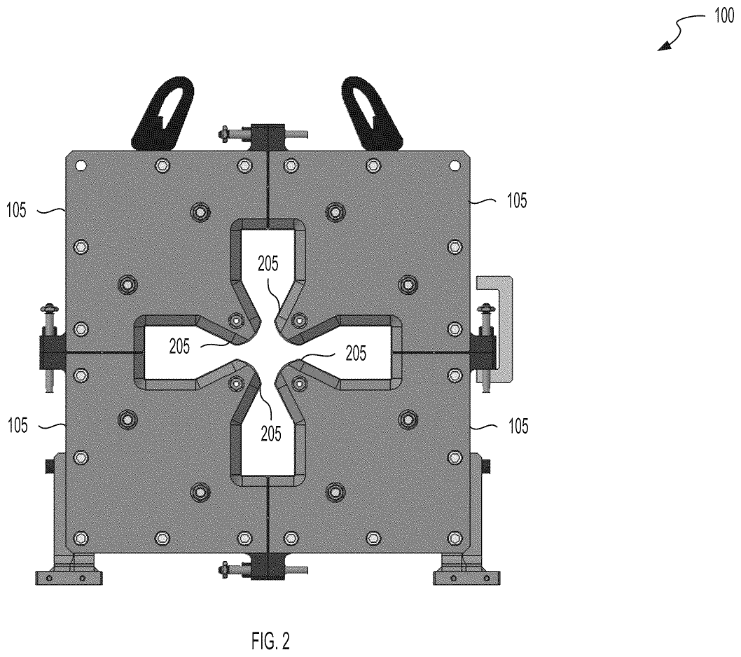

FIG. 2 illustrates a schematic diagram of the assembly 100. The assembly 100 can include the two or more magnet segments 105. For example, the assembly 100 can include four magnet segments 105 to form a quadrupole magnet. Each of the magnet segments 105 can include a pole tip 205. For example, the first magnet segment 105 can include a first pole tip 205. The second magnet segment 105 can include a second pole tip 205. The third magnet segment 105 can include a third pole tip 205. The fourth magnet segment 105 can include a fourth pole tip 205. Each of the pole tips 205 can be oriented toward the center of the assembly 100. One or more coils can be positioned (e.g., arranged, disposed) around the one or more pole tips 205.

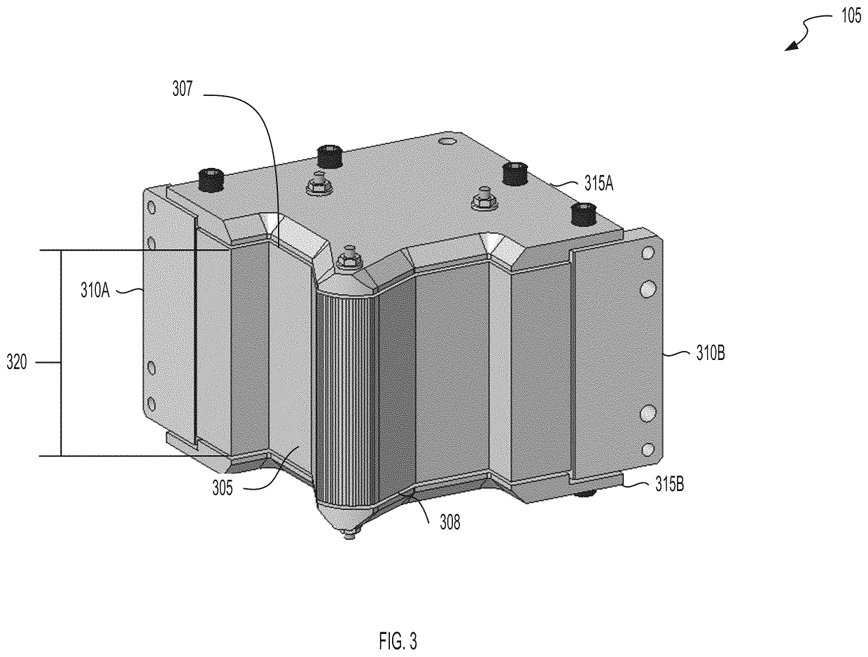

FIG. 3 illustrates a schematic diagram of the magnet segment 105. The magnet segment 105 can include a lamination stack 305. The lamination stack 305 can include a first end 307 of the lamination stack 305. The lamination stack 305 can include a second end 308 of the lamination stack 305. The length of the lamination stack 305 can be defined by a core length 320. The core length can be greater than, equal to, or less than 5 inches.

The magnet segment 105 can include one or more side plates 310. The one or more side plates 310 can include a first side plate 310a. The one or more side plates 310 can include a second side plate 310b. The first side plate 310a can be coupled with the first end 307 of the lamination stack 305. The first side plate 310a can be coupled with the second end 308 of the lamination stack 305. The second side plate 310b can be coupled with the first end 307 of the lamination stack 305. The second side plate 310b can be coupled with the second end 308 of the lamination stack 305.

The magnet segment 105 can include one or more end plates 315. The one or more end plate 315 can include a first end plate 315a. The one or more end plate 315 can include a second end plate 315b. The first end plate 315a can be coupled with the first end 307 of the lamination stack 305. For example, the first end plate 315a can be positioned at the first end 307 of the lamination stack 305. The second end plate 315b can be coupled with the second end 308 of the lamination stack 305. For example, the second end plate 315b can be positioned at the second end 308 of the lamination stack 305.

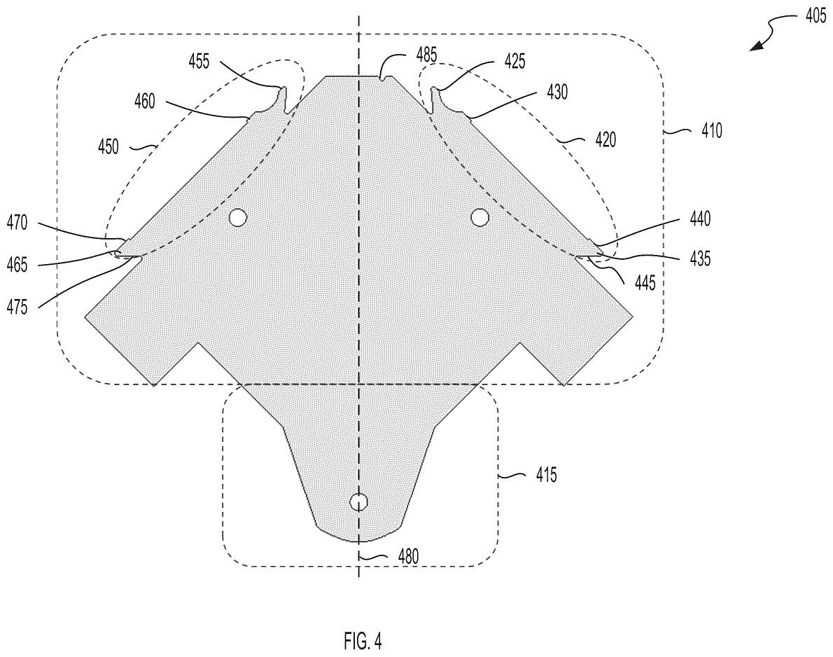

FIG. 4 illustrates a schematic diagram of a lamination 405. The lamination stack 305 can include a plurality of laminations 405. The plurality of laminations 405 can be positioned in a stacked configuration. For example, each lamination 405 can be on top of or below one or two laminations 405. The plurality of laminations 405 can form a stack. The plurality of laminations 405 can include (e.g., be made of) silicon-iron. The lamination 405 can be made of a magnetic material. The lamination 405 can be made of a different material than the end plate 315. The lamination 405 can be made of a different material than the side plate 310. The plurality of laminations 405 can include at least one of laser-cut laminations or stamped laminations. For example, the plurality of laminations 405 can include laser-cut laminations. The laser-cut laminations can be repeatable to within 25 microns. Each of the laminations 405 can be formed using a laser. The plurality of laminations 405 can include stamped laminations. The stamped laminations can be repeatable to within 10 microns. Each of the laminations 405 can be formed using a stamping die. The precision of the stamped laminations can be greater than the precision of the laser-cut laminations.

Each of the plurality of laminations 405 can include a first end 410 of the lamination 405. The first end 410 of the lamination 405 can include a first portion 420 of the first end 410 of the lamination 405. The first portions 420 of the first ends 410 of the plurality of laminations 405 can couple with the first side plate 310a. For example, the first portions 420 of the first ends 410 of the plurality of laminations 405 can be mechanically attached to the first side plate 310a.

The first portion 420 can include a first arm spring 425. The first arm spring 425 can ensure that the position of the lamination 405 is fixed relative to a component. The first arm spring 425 can include a protrusion. For example, the first arm spring 425 can include a flexible (e.g., bendable) protrusion. The first portion 420 can include a plurality of reference surfaces. For example, the first portion 420 can include at least three reference surfaces. The first portion 420 can include a first reference surface 430. The first reference surface 430 can be positioned a first distance from the first arm spring 425.

The first portion 420 can include a first spring clamp base 435. The first spring clamp base 435 can be positioned a second distance from the first arm spring 425. The first distance can be different from the second distance. The second distance can be greater than the first distance. The first spring clamp base 435 can be used to accurately position the lamination 405. The first spring clamp base 435 can include a second reference surface 440. The second reference surface 440 can align with the first reference surface 430. For example, the second reference surface 440 and the first reference surface can be positioned along the same line. The first spring clamp base 435 can include a third reference surface 445. The third reference surface 445 can be oblique to the second reference surface 440. The first arm spring 425 can push the lamination 405 against the first reference surface 430, the second reference surface 440, and the third reference surface 445.

The first end 410 of the lamination 405 can include a second portion 450 of the first end 410 of the lamination 405. The second portions 450 of the first ends 410 of the plurality of laminations 405 can couple with the second side plate 310b. For example, the second portions 450 of the first ends 410 of the plurality of laminations 405 can be mechanically attached to the second side plate 310b.

The second portion 450 can include a second arm spring 455. The second arm spring 455 can ensure that the position of the lamination 405 is fixed relative to a component. The second arm spring 455 can include a protrusion. For example, the second arm spring 455 can include a flexible protrusion. The second portion 450 can include a plurality of reference surfaces. For example, the second portion 450 can include at least three reference surfaces. The second portion 450 can include a fourth reference surface 460. The fourth reference surface 460 can be positioned a third distance from the second arm spring 455.

The second portion 450 can include a second spring clamp base 465. The second spring clamp base 465 can be positioned a fourth distance from the second arm spring 455. The third distance can be different from the fourth distance. The fourth distance can be greater than the third distance. The second spring clamp base 465 can be used to accurately position the lamination 405. The second spring clamp base 465 can include a fifth reference surface 470. The fifth reference surface 470 can align with the fourth reference surface 460. For example, the fifth reference surface 470 and the fourth reference surface 460 can be positioned along the same line. The second spring clamp base 465 can include a sixth reference surface 475. The sixth reference surface 475 can be oblique to the fifth reference surface 470. The second arm spring 455 can push the lamination 405 against the fourth reference surface 460, the fifth reference surface 470, and the sixth reference surface 475.

Each of the plurality of laminations 405 can include a second end 415. The second end 415 of the lamination 405 can be opposite the first end 410 of the lamination 405. The second ends 415 of the plurality of laminations 405 can form the pole tip 205. The second end 415 of the lamination 405 can be shaped to allow space for the one or more coils to be arranged around the pole tip 205.

The lamination 405 can include a lamination axis 480. The lamination axis 480 can be oriented between the first end 410 of the lamination 405 and the second end 415 of the lamination 405. The lamination axis 480 can be oriented along a mirror plane of the lamination 405. The lamination axis 480 can separate the first portion 420 of the first end 410 of the lamination 405 from the second portion 450 of the first end 410 of the lamination 405.

The lamination 405 can include a witness mark 485. The witness mark 485 can be positioned at the first portion 420 of the first end 410 of the lamination 405. The witness mark 485 can include at least one of a groove, inset, cut, or protrusion. The witness mark 485 can break the symmetry of the lamination 405. For example, the witness mark 485 can break the reflection symmetry of the lamination 405. The witness mark 485 can be positioned on a first side of the lamination axis 480. The witness mark 485 can be positioned on the first portion 420 of the first end 410 of the lamination 405 or the second portion 450 of the first end 410 of the lamination 405.

The lamination 405 can be stamped with a 2-stage stamping die. The first stage can produce a rough cut that allows any internal stresses in the material to relax. The second stage can produce the final precise lamination cut. The stamping repeatability of the laminations 405 can be within 10 microns. This repeatability can help to sustain assembly precision for the tip gaps and the aperture gaps. Each lamination 405 of the plurality of laminations 405 can have the same shape. Each lamination 405 of the plurality of laminations 405 can have the same errors in the same spots.

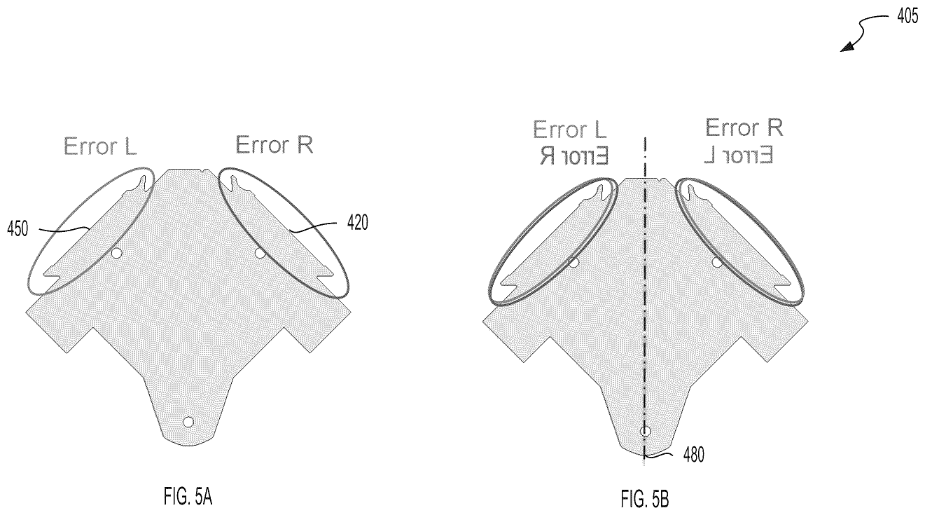

FIGS. 5A and 5B illustrate schematic diagrams of the laminations 405. FIG. 5A illustrates the lamination 405 before stacking. FIG. 5B illustrates the lamination 405 after stacking (e.g., flipping). The errors in the lamination 405 can be systematic. For example, the errors (e.g., Error R, right error) in the first portion 420 of the first end 410 of the lamination 405 can be different from the errors (e.g., Error L, left error) in the second portion 450 of the first end 410 of the lamination 405. Error R can be the nearly the same or the same for each of the plurality of laminations 405. Error L can be the nearly the same or the same for each of the plurality of laminations 405.

The plurality of laminations 405 can form the lamination stack 305. The lamination stack 305 can form the core (e.g., magnet core). The plurality of laminations 405 can be stacked by shuffling and flipping such that one set of laminations 405 are oriented in one direction and the other set of laminations 405 are oriented in another direction. For example, the plurality of laminations 405 can be stacked by aligning the first end 410 of a first lamination 405 with the first end 410 of a second lamination 405. The plurality of laminations 405 can be stacked by aligning the first portion 420 of the first end 410 of the first lamination 405 with the second portion 450 of the first end 410 of the second lamination 405. The second lamination 405 can be flipped along the lamination axis 480 and stacked on top of the first lamination 405. The plurality of laminations 405 can be stacked by shuffling and flipping such that half of the laminations 405 face one way while the other half of the laminations 405 face the other way. The systematic errors can become mirror images in the core by stacking. For example, the lamination stack 305 can be symmetric with respect to the lamination axis 480.

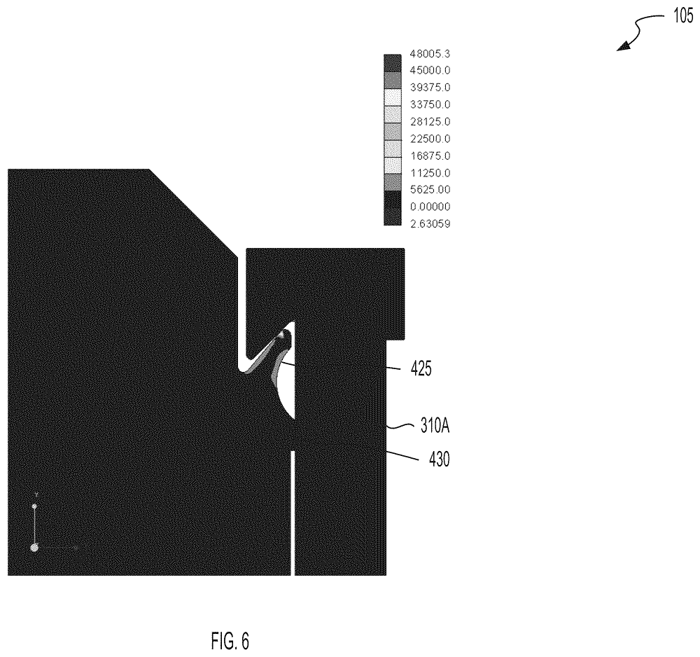

FIG. 6 illustrates a diagram of a portion of the magnet segment 105 (e.g., main body). The magnet segment 105 can include the lamination 405. The lamination 405 can include the first arm spring 425 and the first reference surface 430. The magnet segment 105 can include the first side plate 310a. The first arm spring 425 can press against the first side plate 310a. The force on the first arm spring 425 can be concentrated at the tip of the first arm spring 425. The force on the first arm spring 425 applied by the first side plate 310a can be the same as or different from the force on the second arm spring 455 applied by the second side plate 310b.

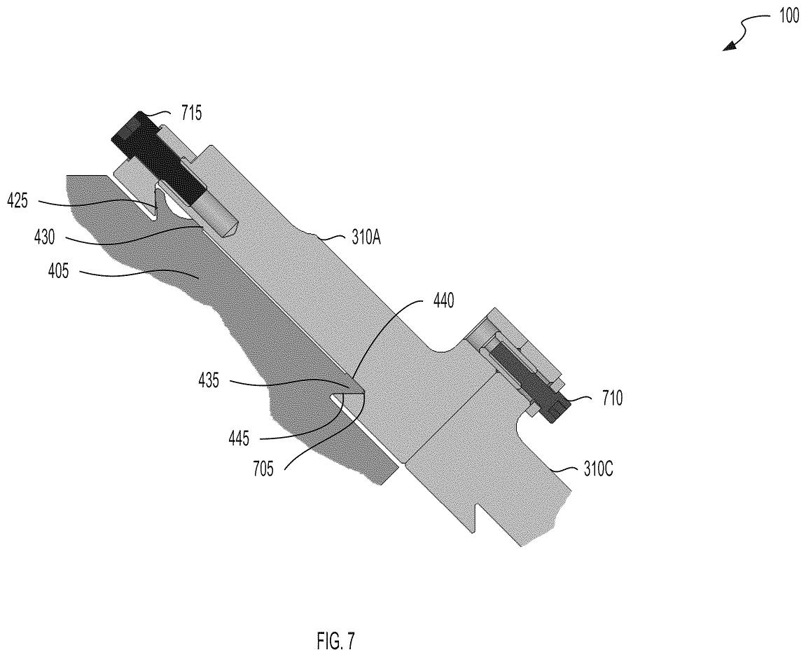

FIG. 7 illustrates a schematic diagram of a portion of the magnet assembly 100. The magnet assembly 100 can include the lamination 405. The lamination 405 can include the first arm spring 425, the first reference surface 430, the first spring clamp base 435. The magnet assembly 100 can include the first side plate 310a. The first arm spring 425 can press against the first side plate 310a.

The magnet assembly 100 can include a plurality of spring clamp stops 705. For example, the magnet assembly 100 can include a first spring clamp stop 705. The first side plate 310a can include the first spring clamp stop 705. The first spring clamp stop 705 can be a groove in the first side plate 310a. The first spring clamp stop 705 can include the first reference surface 430. The first spring clamp stop 705 can include the second reference surface 440. The first spring clamp stop 705 can include the third reference surface 445. For each of the plurality of laminations 405, the first spring clamp base 435 can couple with the first spring clamp stop 705. For example, the first spring clamp base 435 can be inserted into the first spring clamp stop 705. The first spring clamp base 435 can form a dovetail (e.g., dovetail joint) with the first spring clamp stop 705. The second reference surface 440 can be adjacent to the first spring clamp stop 705. The third reference surface 445 can be adjacent to the first spring clamp stop 705. The first arm spring 425 can ensure that the position of the lamination 405 is fixed relative to the first spring clamp stop 705. For example, the first arm spring 425 can ensure that the position of the lamination 405 is bottomed out at the first spring clamp stop 705.

The magnet assembly 100 can include a tapered pin 710. The tapered pin 710 can couple the first side plate 310a with a third side plate 310c. The tapered pin 710 can fix the distance between the first side plate 310a and the third side plate 310c. The tapered pin 710 can be removed from the side plates 310 and rejoin the side plates 310 in a reproducible manner.

The magnet assembly 100 can include a bolt 715. The bolt 715 can apply a force to onto the first arm spring 425 through the first side plate 310a. For each of the plurality of laminations 405, a first force applied to the first arm spring 425 can cause the lamination 405 to press against the first spring clamp stop 705 at the first reference surface 430, the second reference surface 440, and the third reference surface 445. Tightening with the bolt 715 can push the first side plate 310a against the first arm spring 425. Tightening with the bolt 715 can push the lamination 405 against the spring clamp stop 705.

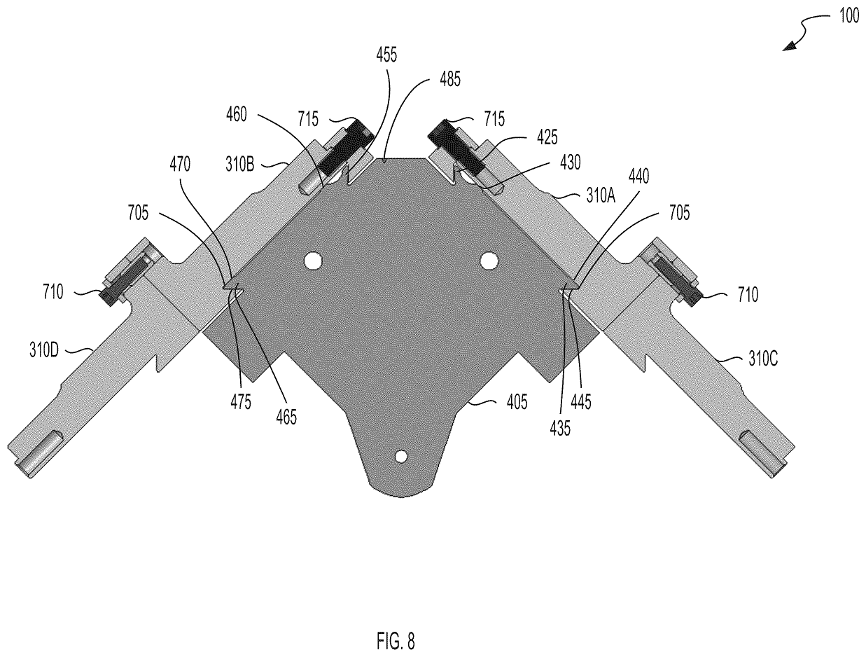

FIG. 8 illustrates a schematic diagram of a portion of the magnet assembly 100. The magnet assembly 100 can include the lamination 405. The magnet assembly 100 can include a plurality of side plates 310. The magnet assembly 100 can include a plurality of bolts 715. For example, the magnet assembly 100 can include the first bolt 715. The magnet assembly 100 can include a second bolt 715. The magnet assembly 100 can include a plurality of tapered pins 710. The magnet assembly 100 can include the first arm spring 425, the witness mark 485, the first spring clamp stop 705, the first side plate 310a, the second side plate 310b, the first spring clamp base 435, the first reference surface 430, the second reference surface 440, the third reference surface 445, the second arm spring 455, the second spring clamp stop 705, the third side plate 310c, a fourth side plate 310d, the second spring clamp base 465, the fourth reference surface 460, the fifth reference surface 470, and the sixth reference surface 475.

The magnet assembly 100 can include a second spring clamp stop 705. The second side plate 310b can include the second spring clamp stop 705. The second spring clamp stop 705 can be a groove in the second side plate 310b. The second spring clamp stop 705 can include the fourth reference surface 460. The second spring clamp stop 705 can include the fifth reference surface 470. The second spring clamp stop 705 can include the sixth reference surface 475. For each of the plurality of laminations 405, the second spring clamp base 465 can couple with the second spring clamp stop 705. For example, the second spring clamp base 465 can be inserted into the second spring clamp stop 705. The fifth reference surface 470 can be adjacent to the second spring clamp stop 705. The sixth reference surface 475 can be adjacent to the second spring clamp stop 705. The second arm spring 455 can ensure that the position of the lamination 405 is fixed relative to the second spring clamp stop 705. For example, the second arm spring 455 can ensure that the position of the lamination 405 is bottomed out at the second spring clamp stop 705.

For each of the plurality of laminations 405, the first force applied to the first arm spring 425 can cause the lamination 405 to press against the first spring clamp stop 705 at the first reference surface 430, the second reference surface 440, and the third reference surface 445. The first bolt 715 can apply the first force. For each of the plurality of laminations 405, a second force applied to the second arm spring 455 can cause the lamination 405 to press against the second spring clamp stop 705 at the fourth reference surface 460, the fifth reference surface 470, and the sixth reference surface 475. The second bolt 715 can apply the second force. Tightening with the first bolt 715 can push the first side plate 310a against the first arm spring 425. Tightening with the first bolt 715 can push the lamination 405 against the spring clamp stop 705. Tightening with the second bolt 715 can push the second side plate 310b against the second arm spring 455. Tightening with the second bolt 715 can push the lamination 405 against the spring clamp stop 705. Each lamination 405 can be accurately positioned against the spring clamp stops 705. The spring clamp assembly errors can be mirrored.

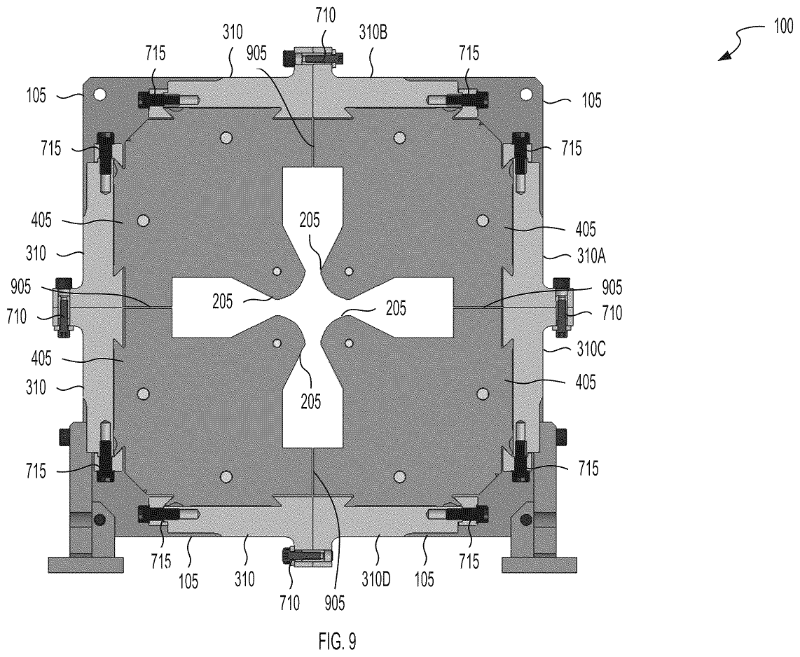

FIG. 9 illustrates a schematic diagram of the magnet assembly 100. The magnet assembly 100 can include a quadrupole magnet. The magnet assembly 100 can include the plurality of laminations 405. The magnet assembly 100 can include the plurality of side plates 310. The magnet assembly 100 can include the plurality of bolts 715. The magnet assembly 100 can include the plurality of tapered pins 710. The magnet assembly 100 can include the plurality of magnet segments 105. The plurality of magnet segments 105 can include the first magnet segment 105. The plurality of magnet segments 105 can include the second magnet segment 105. The plurality of magnet segments 105 can include the third magnet segment 105. The plurality of magnet segments 105 can include the fourth magnet segment 105. The magnet assembly 100 can include the plurality of pole tips 205. The plurality of magnet segments 105 can have the same systematic errors.

The first magnet segment 105 can include the first pole tip 205, the first side plate 310a, and the second side plate 310b. The second magnet segment 105 can include the second pole tip 205, the third side plate 310c, and the fourth side plate 310d. The tapered pin 710 can couple the first side plate 310a with the third side plate 310c.

The magnet assembly 100 can include a plurality of gaps 905. The plurality of gaps 905 can allow the plurality of laminations 405 from different magnet segments 105 to be separated from each other. Each of the plurality of gaps 905 can be 100 microns. The plurality of gaps 905 can include a first gap 905. The first gap 905 can separate the first magnet segment 105 from the second magnet segment 105. The plurality of gaps 905 can include a second gap 905. The second gap 905 can separate the second magnet segment 105 from the third magnet segment 105. The plurality of gaps 905 can include a third gap 905. The third gap 905 can separate the third magnet segment 105 from the fourth magnet segment 105. The plurality of gaps 905 can include a fourth gap 905. The fourth gap 905 can separate the fourth magnet segment 105 from the first magnet segment 105.

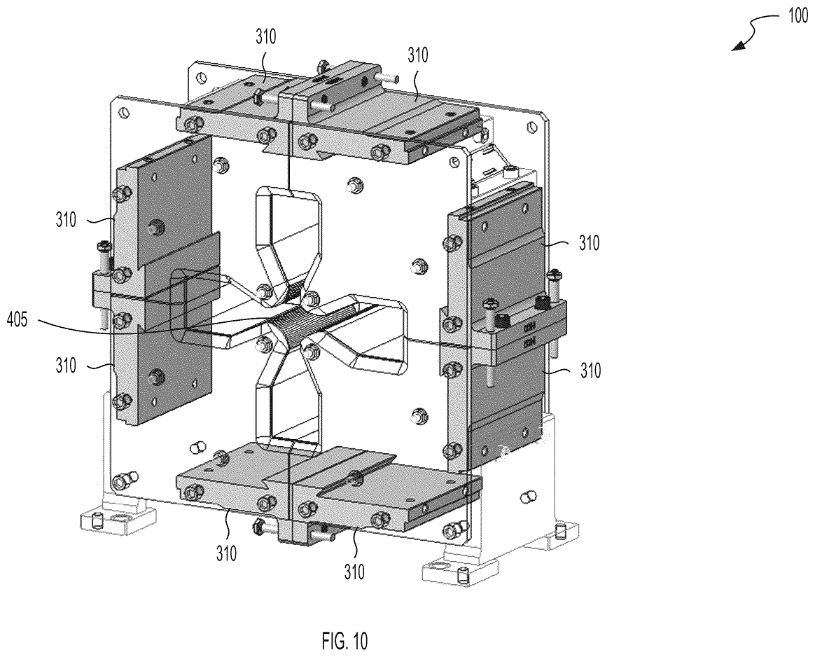

FIG. 10 illustrates a schematic diagram of the magnet assembly 100. The magnet assembly 100 can include a quadrupole magnet. The magnet assembly 100 can include the plurality of laminations 405. The magnet assembly 100 can include the plurality of side plates 310. The pairs of side plates 310 can form a matched set. The matched set of side plates 310 can have side plate reference surface dimension measurements performed with the same measurement pins. The matched set of side plates 310 can have side plate reference surface dimension measurements within a threshold value for the profile tolerance. The threshold value for the profile tolerance can be 25 microns.

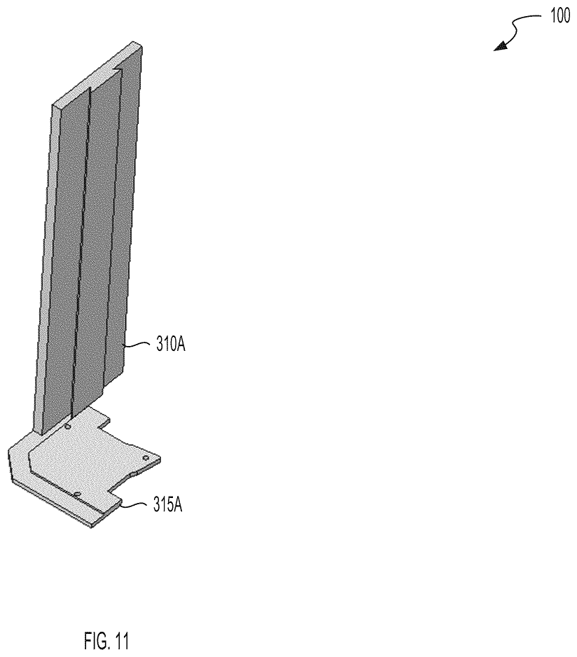

FIG. 11 illustrates a schematic diagram of a portion of the magnet assembly 100. The magnet assembly 100 can include the plurality of end plates 315. The plurality of end plates 315 can include one or more recess. The recess can allow the side plates 310 to overlap the plurality of laminations 405. The magnet assembly 100 can include the first end plate 315a. The first end plate 315a can include a first recess. The first recess can receive the first side plate 310a. The first recess can couple with the first side plate 310a. The magnet assembly 100 can include the second end plate 315. The second end plate 315 can include a second recess. The second recess can receive the second side plate 310b. The second recess can couple with the second side plate 310b. The magnet assembly 100 can include the plurality of side plates 310. For example, the magnet assembly 100 can include the first side plate 310a. The magnet assembly 100 can include the second side plate 310b.

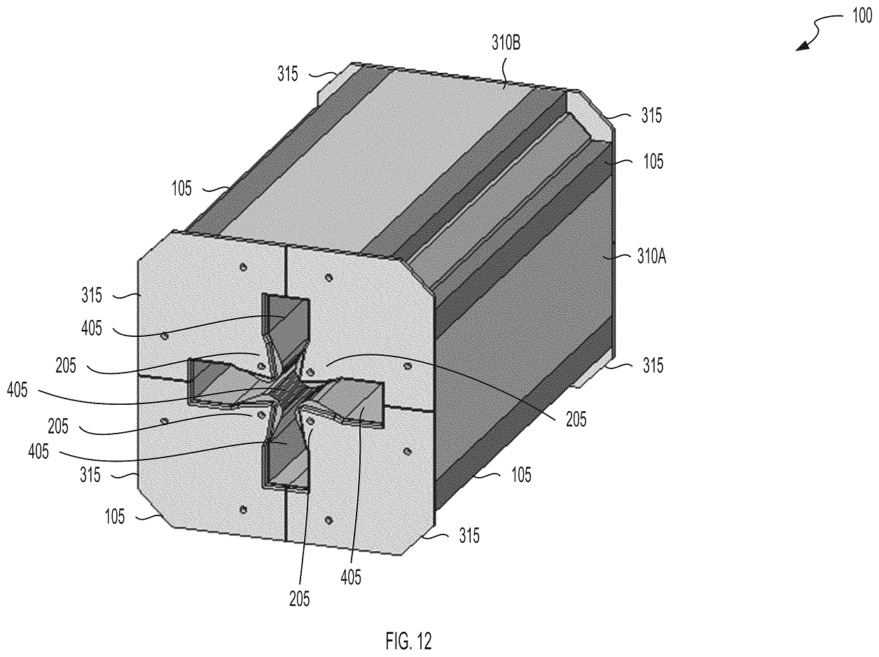

FIG. 12 illustrates a schematic diagram of a portion of the magnet assembly 100. The magnet assembly 100 can include the plurality of magnet segments 105. The magnet assembly 100 can include the plurality of end plates 315. The magnet assembly 100 can include the plurality of side plates 310. The magnet assembly 100 can include the plurality of laminations 405. The plurality of laminations 405 can include a first plurality of laminations 405. The plurality of laminations 405 can include a second plurality of laminations 405. The plurality of laminations 405 can include the third plurality of laminations 405. The plurality of laminations 405 can include a fourth plurality of laminations 405.

The magnet assembly 100 can include the plurality of magnet segments 105. The plurality of magnet segments 105 can include the first magnet segment 105. The first magnet segment 105 can include the first plurality of laminations 405. The first magnet segment 105 can include the first pole tip 205. The plurality of magnet segments 105 can include the second magnet segment 105. The second magnet segment 105 can include the second plurality of laminations 405. The second magnet segment 105 can include the second pole tip 205. The plurality of magnet segments 105 can include the third magnet segment 105. The third magnet segment 105 can include the third plurality of laminations 405. The third magnet segment 105 can include the third pole tip 205. The plurality of magnet segments 105 can include the fourth magnet segment 105. The fourth magnet segment 105 can include the fourth plurality of laminations 405. The fourth magnet segment 105 can include the fourth pole tip 205.

The first plurality of laminations 405 can be separated from the second plurality of laminations 405 by the first gap 905. The second plurality of laminations 405 can be separated from the third plurality of laminations 405 by the second gap 905. The third plurality of laminations 405 can be separated from the fourth plurality of laminations 405 by the third gap 905. The fourth plurality of laminations 405 can be separated from the first plurality of laminations 405 by the fourth gap 905.

A first set of end plates 315 of the plurality of end plates 315 can be positioned on a first side of the plurality of side plates 310. A second set of end plates 315 of the plurality of end plates 315 can be positioned on second side of the plurality of side plates 310. The second side of the plurality of side plates 310 can be opposite the first side of the plurality of side plates 310. The first set of end plates 315 of the plurality of end plates 315 and the second set of end plates 315 of the plurality of end plates 315 can apply a compressive force to the plurality of laminations 405. The end plates 315 can provide support to compress the plurality of laminations 405. For example, the end plates 315 can provide support to compress the plurality of laminations 405 to 400 psi. The end plates 315 can prevent the laminations 405 from delaminating. The end plates 315 can force the side plates 310 to be perpendicular to the lamination stack 305. The plurality of laminations 405 can be epoxy bonded or glued together.

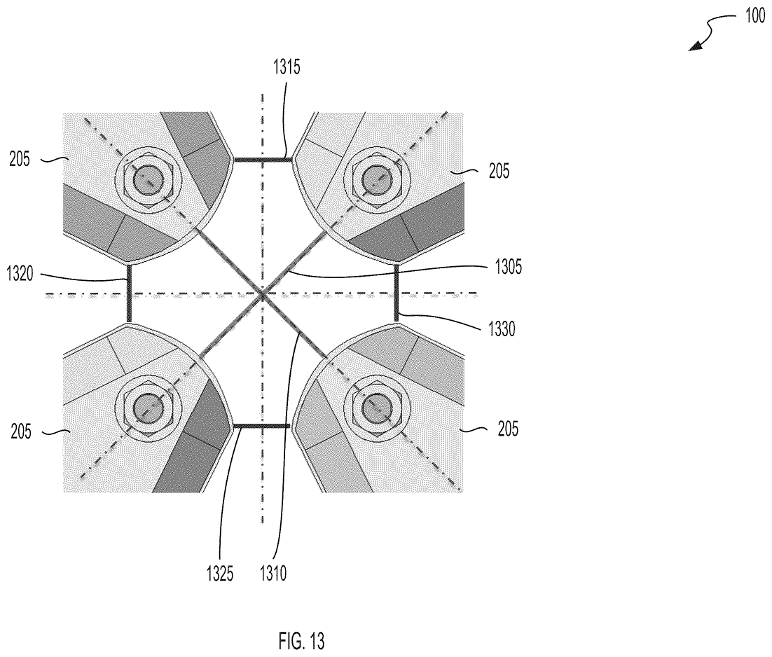

FIG. 13 illustrates a schematic diagram of a portion of the magnet assembly 100. The magnet assembly 100 can include the plurality of magnet segments 105. The plurality of magnet segments 105 can include the first magnet segment 105. The plurality of magnet segments 105 can include the second magnet segment 105. The plurality of magnet segments 105 can include the third magnet segment 105. The plurality of magnet segments 105 can include the fourth magnet segment 105.

A first pole tip distance 1305 can be defined by a distance between the first pole tip 205 and the third pole tip 205. The distance between the first pole tip 205 and the third pole tip 205 can define a first aperture gap. A second pole tip distance 1310 can be defined by a distance between the second pole tip 205 and the fourth pole tip 205. The distance between the second pole tip 205 and the fourth pole tip 205 can define a second aperture gap. An absolute value of a difference between the first pole tip distance 1305 and the second pole tip distance 1310 can be less than a threshold value (e.g., first threshold value). The first threshold value can be 50 microns for a 40 mm aperture (e.g., 40 mm aperture gap). The first threshold value can be 35 microns for a 26 mm aperture (e.g., 26 mm aperture gap). The absolute value of the difference between the first pole tip distance 1305 and the second pole tip distance 1310 can be less than the first threshold value by using the spring clamp method. The first pole tip distance 1305 can be equal to the second pole tip distance 1310.

A third pole tip distance 1315 can be defined by a distance between the first pole tip 205 and the second pole tip 205. The distance between the first pole tip 205 and the second pole tip 205 can define a first tip gap. A fourth pole tip distance 1320 can be defined by a distance between the second pole tip 205 and the third pole tip 205. The distance between the second pole tip 205 and the third pole tip 205 can define a second tip gap. A fifth pole tip distance 1325 can be defined by a distance between the third pole tip 205 and the fourth pole tip 205. The distance between the third pole tip 205 and the fourth pole tip 205 can define a third tip gap. A sixth pole tip distance 1330 is defined by a distance between the fourth pole tip 205 and the first pole tip 205. The distance between the fourth pole tip 205 and the first pole tip 205 can define a fourth tip gap.

An average distance can be defined by an average of the third pole tip distance 1315, the fourth pole tip distance 1320, the fifth pole tip distance 1325, and the sixth pole tip distance 1330. A maximum distance can be defined by a maximum of the third pole tip distance 1315, the fourth pole tip distance 1320, the fifth pole tip distance 1325, and the sixth pole tip distance 1330. A minimum distance can be defined by a minimum of the third pole tip distance 1315, the fourth pole tip distance 1320, the fifth pole tip distance 1325, and the sixth pole tip distance 1330.

A difference between the maximum distance and the average distance can be less than a threshold value (e.g., second threshold value). The difference between the maximum distance and the average distance can be less than the second threshold value using the spring clamp method. The second threshold value can be 50 microns for a 40 mm aperture. The second threshold value can be 35 microns for a 26 mm aperture. A difference between the average distance and the minimum distance is less than a threshold value (e.g., third threshold value). The difference between the average distance and the minimum distance can be less than the third threshold value using the spring clamp method. The third threshold value can be 50 microns for a 40 mm aperture. The third threshold value can be 35 microns for a 26 mm aperture. The third threshold value can be equal to the second threshold value.

The tolerance distribution can be symmetrical in 3 planes (e.g., 3-fold-symmetry). Deflections and forces can be 3-fold-symmetric. This can force symmetrical spaces for the tip gaps and the aperture gaps. The first pole tip distance 1305 and the second pole tip distance 1310 can be forced to be equal. The third pole tip distance 1315, the fourth pole tip distance 1320, the fifth pole tip distance 1325, and the sixth pole tip distance 1330 can be forced to be equal.

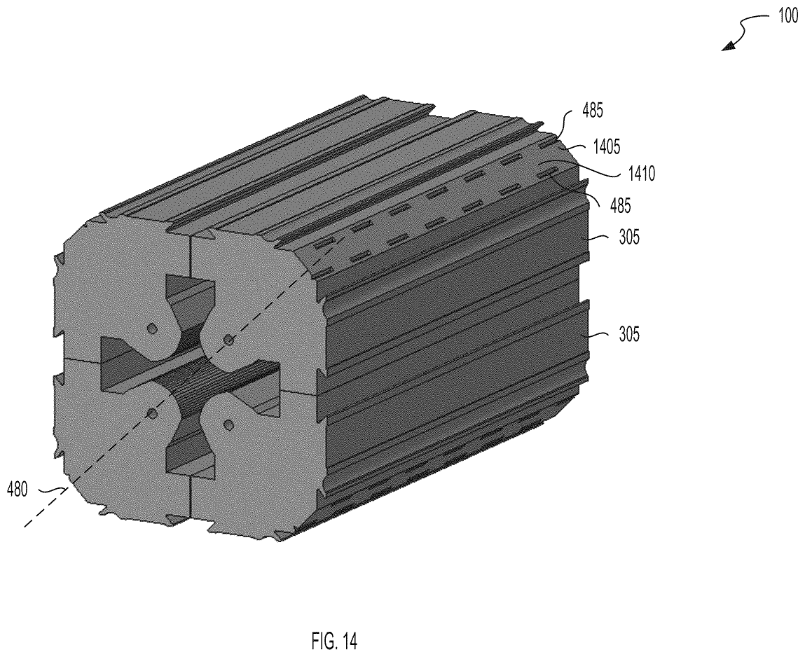

FIG. 14 illustrates a schematic diagram of a portion of the magnet assembly 100. The magnet assembly 100 can include the lamination stack 305. The lamination stack 305 can include the plurality of laminations 405. The plurality of laminations 405 can include a plurality of lamination sets. Each lamination set can have witness marks 485 oriented in the same direction. Each lamination set can have a length of 0.8 inches. The plurality of laminations 405 can include a first set 1405 of laminations 405. The first set 1405 of laminations 405 can be oriented in a first direction. The plurality of laminations 405 can include a second set 1410 of laminations 405. The second set 1410 of laminations 405 can be oriented in a second direction. The second set 1410 of laminations 405 can be positioned adjacent to the first set 1405 of laminations 405.

The witness marks 485 of the first set 1405 of laminations 405 can be positioned on a first side of the lamination axis 480. The lamination axis 480 can include a line between the first end 410 of the lamination 405 and the second end 415 of the lamination 405. The witness marks 485 of the second set 1410 of laminations 405 can be positioned on a second side of the lamination axis 480. For example, the witness marks 485 of the second set 1410 of laminations 405 can be positioned on the second side of the line between the first end 410 of the lamination 405 and the second end 415 of the lamination 405.

The lamination stack 305 can have alternating witness marks 485. Each set of laminations 405 can include one or more laminations 405. The witness marks 485 of the first set 1405 of laminations 405 can be oriented in the first direction. The witness marks 485 of the second set 1410 of laminations 405 can be oriented in the second direction. The second set 1410 of laminations 405 can be positioned adjacent to the first set 1405 of laminations 405. The witness marks 485 of a third set of laminations 405 can be oriented in the first direction. The third set of laminations 405 can be positioned adjacent to the second set 1410 of laminations 405. The witness marks 485 of a fourth set of laminations 405 can be oriented in the second direction. The fourth set of laminations 405 can be positioned adjacent to the third set of laminations 405. The witness marks 485 of a fifth set of laminations 405 can be oriented in the first direction. The fifth set of laminations 405 can be positioned adjacent to the fourth set of laminations 405. The witness marks 485 of a sixth set of laminations 405 can be oriented in the second direction. The sixth set of laminations 405 can be positioned adjacent to the fifth set of laminations 405.

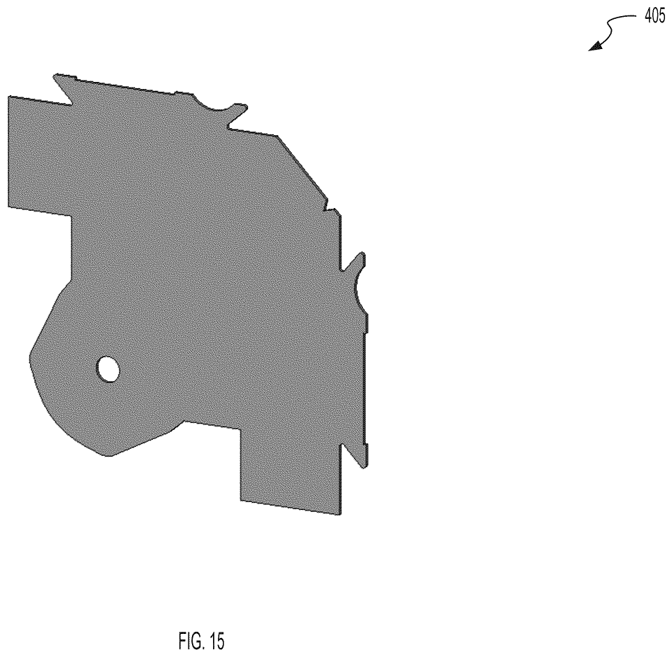

FIG. 15 illustrates a schematic diagram of the lamination 405. The lamination 405 can have a thickness of 0.025 inches. The lamination 405 can have a thickness of about 0.5 mm. The lamination 405 can have a thickness in a range of 0.4 mm to 0.7 mm. The lamination 405 can have a weight of 0.24 lbs. The lamination 405 can have an area of 34.55 square inches.

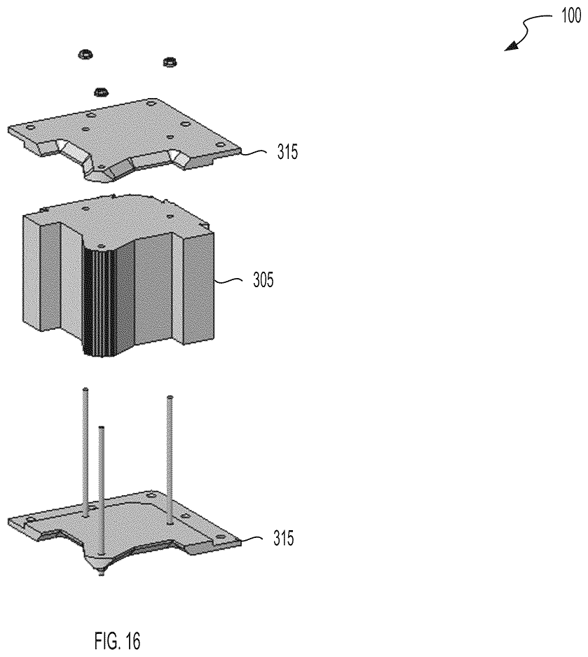

FIG. 16 illustrates a schematic diagram of a portion of the magnet assembly 100. The diagram is an exploded view of the portion of the magnet assembly 100 including the lamination stack 305 and the end plates 315. The lamination stack 305 can form the core. The thickness of the core can be 5 inches. The weight of the core can be 47.68 lbs.

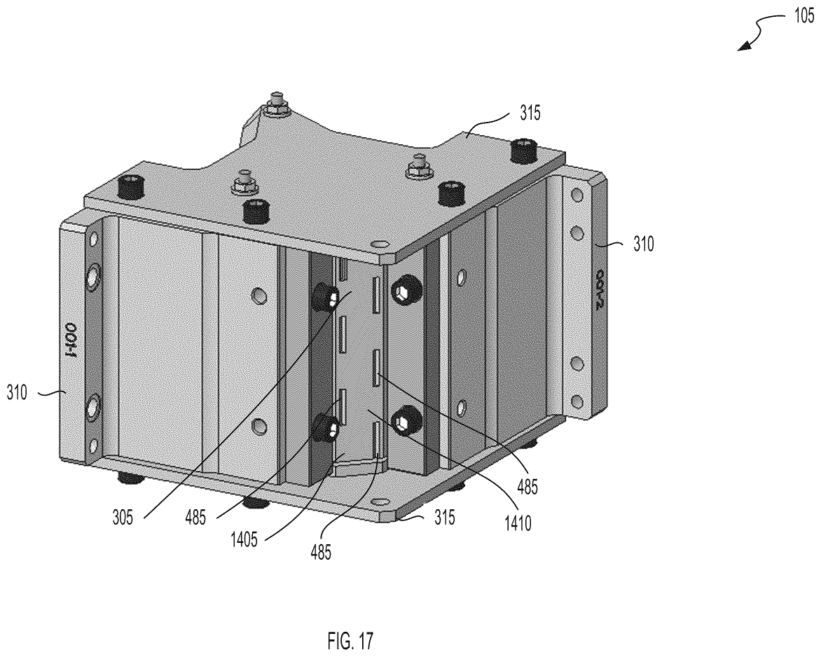

FIG. 17 illustrates a schematic diagram of the magnet segment 105. The magnet segment 105 can include one or more side plates 310. The magnet segment 105 can include the one or more end plates 315. The magnet segment 105 can include the lamination stack 305. The lamination stack 305 can include the first set 1405 of laminations 405 oriented in the first direction. The lamination stack 305 can include the second set 1410 of laminations 405 oriented in second first direction. The second set 1410 of laminations 405 can be positioned adjacent to the first set 1405 of laminations 405. For example, the second set 1410 of laminations 405 can be positioned on top of the first set 1405 of laminations 405. The lamination stack 305 can include a third set of laminations 405 oriented in the first direction. The third set of laminations 405 can be positioned adjacent to the second set 1410 of laminations 405. For example, the third set of laminations 405 can be positioned on top of the second set 1410 of laminations 405. The lamination stack 305 can include a fourth set of laminations 405 oriented in the second direction. The fourth set of laminations 405 can be positioned adjacent to the third set of laminations 405. For example, the fourth set of laminations 405 can be positioned on top of the third set of laminations 405. The plurality of laminations 405 can be received with the witness marks 485 for each of the plurality of laminations 405 oriented in the same direction. Each set of laminations 405 can be positioned adjacent to one or two sets of laminations 405 with the witness marks 485 arranged in an alternating manner. Alternating sets of laminations 405 can be flipped using the witness marks 485 as indicators.

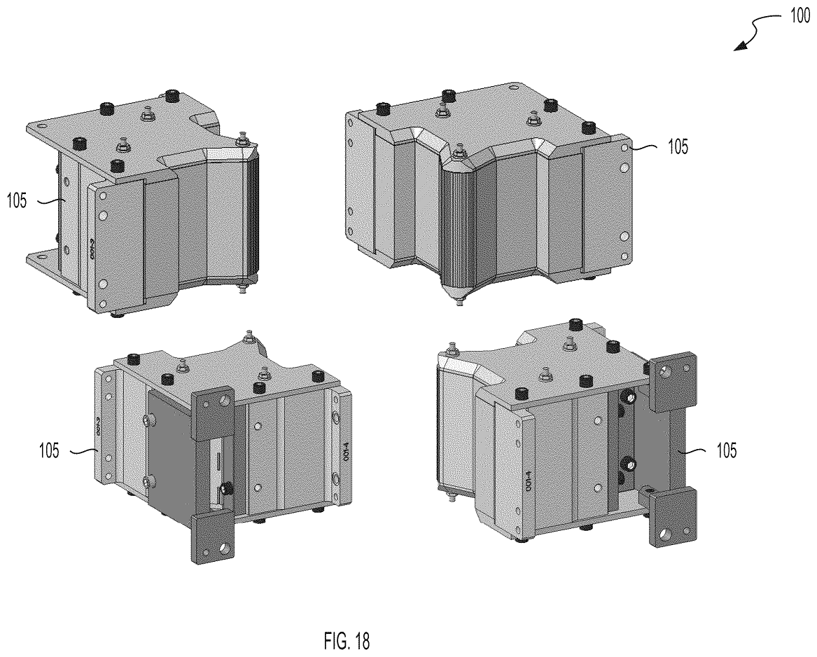

FIG. 18 illustrates a schematic diagram of a portion of the magnet assembly 100. The magnet assembly 100 can include the plurality of magnet segments 105. For example, the magnet assembly 100 can include the first magnet segment 105. The magnet assembly 100 can include the second magnet segment 105. The magnet assembly 100 can include the third magnet segment 105. The magnet assembly 100 can include the fourth magnet segment 105. The plurality of magnet segments 105 can be oriented horizontally before alignment.

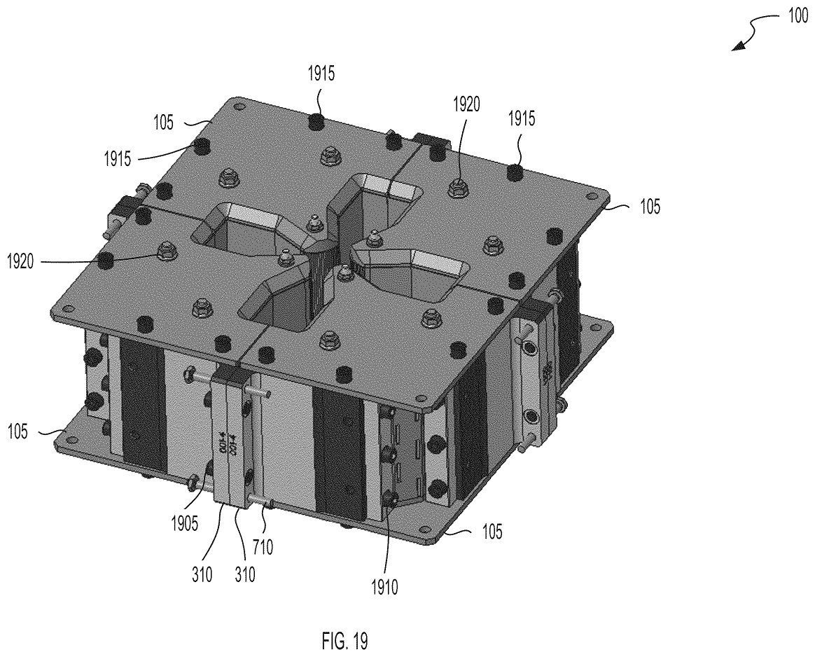

FIG. 19 illustrates a schematic diagram of the magnet assembly 100. The magnet assembly 100 can include the plurality of magnet segments 105. For example, the magnet assembly 100 can include the first magnet segment 105. The magnet assembly 100 can include the second magnet segment 105. The magnet assembly 100 can include the third magnet segment 105. The magnet assembly 100 can include the fourth magnet segment 105. The plurality of magnet segments 105 can be oriented horizontally (e.g., sideways) during alignment. The orientation of the plurality of magnet segments 105 in this way can reduce or eliminate stresses from gravity.

A plurality of flange bolts 1905, a plurality of tapered pins 710, a plurality of side plate bolts 1910, a plurality of end plate bolts 1915, and a plurality of tie rod nuts 1920 can be torqued in sequence. The plurality of flange bolts 1905 can be torqued while aligning the plurality of side plates 310 with the plurality of tapered pins 710. The plurality of side plate bolts 1910 can be torqued. For example, the plurality of side plate bolts 1910 can be torqued subsequent to torquing the plurality of flange bolts 1905. The plurality of end plate bolts 1915 and the plurality of tie rod nuts 1920 can be torqued. For example, the plurality of end plate bolts 1915 and the plurality of tie rod nuts 1920 can be torqued subsequent to torquing the plurality of side plate bolts 1910.

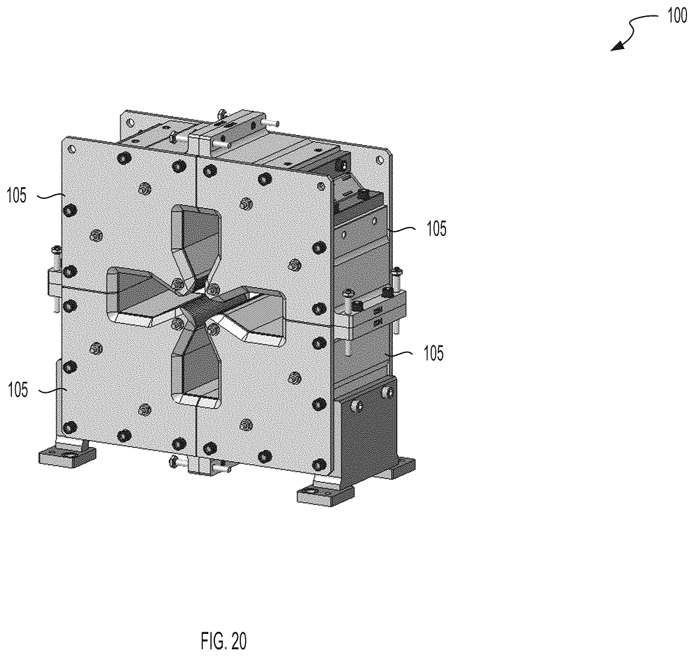

FIG. 20 illustrates a schematic diagram of the magnet assembly 100. The magnet assembly 100 can include the plurality of magnet segments 105. For example, the magnet assembly 100 can include the first magnet segment 105. The magnet assembly 100 can include the second magnet segment 105. The magnet assembly 100 can include the third magnet segment 105. The magnet assembly 100 can include the fourth magnet segment 105. The plurality of magnet segments 105 can be oriented vertically (e.g., upright) during operation of the magnet assembly 100.

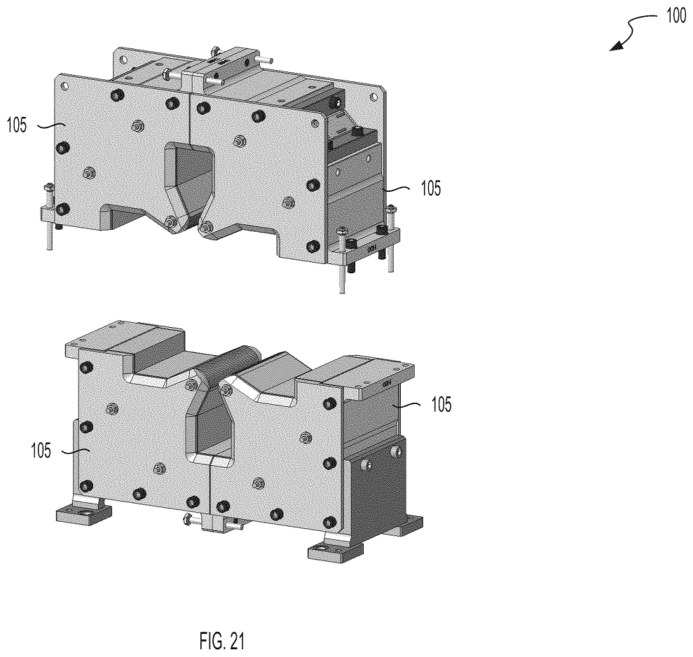

FIG. 21 illustrates a schematic diagram of the magnet assembly 100. The magnet assembly 100 can include the plurality of magnet segments 105. For example, the magnet assembly 100 can include the first magnet segment 105. The magnet assembly 100 can include the second magnet segment 105. The magnet assembly 100 can include the third magnet segment 105. The magnet assembly 100 can include the fourth magnet segment 105. The top part of the magnet assembly 100 can be detached (e.g., split, separated) from the bottom part of the magnet assembly 100. For example, the first magnet segment 105 and the second magnet segment 105 can be separated from the third magnet segment 105 and the fourth magnet segment 105.

A method (e.g., spring clamp method) can include providing the lamination stack. The lamination stack can include the plurality of laminations arranged in a stacked configuration. Each of the plurality of laminations can include the first portion of the first end of the lamination. The first portion of the first end of the lamination can include the first arm spring. The first portion of the first end of the lamination can include the first reference surface positioned the first distance from the first arm spring. The first portion of the first end of the lamination can include the first spring clamp base positioned the second distance from the first arm spring. The first spring clamp base can include the second reference surface and the third reference surface. Each of the plurality of laminations can include the second portion of the first end of the lamination. The second portion of the first end of the lamination can include the second arm spring. The second portion of the first end of the lamination can include the fourth reference surface positioned the third distance from the second arm spring. The second portion of the first end of the lamination can include the second spring clamp base positioned the fourth distance from the second arm spring. The second spring clamp base can include the fifth reference surface and the sixth reference surface. The second end of the plurality of laminations can form the pole tip. The method can include coupling the first side plate with the first portions of the first ends of the plurality of laminations. The method can include coupling the second side plate with the second portion of the first ends of the plurality of laminations. The method can include coupling the first end plate with the first end of the lamination stack. The method can include coupling the second end plate with the second end of the lamination stack.

In some embodiments, the plurality of laminations can include the first plurality of laminations and the second plurality of laminations. The method can include orienting the first plurality of laminations in the first direction. The method can include orienting the second plurality of laminations in the second direction.

In some embodiments, the method can include applying, by the first bolt, for each of the plurality of laminations, the first force to the first arm spring to cause the lamination to press against the first spring clamp stop of the first side plate at the first reference surface, the second reference surface and the third reference surface. The method can include applying, by the second bolt, for each of the plurality of laminations, the second force to the second arm spring to cause the lamination to press against the second spring clamp stop of the second side plate at the fourth reference surface, the fifth reference surface and the sixth reference surface.

In some embodiments, the method can include providing the first magnet segment. The first magnet segment can include the plurality of laminations, the first side plate, the second side plate, the first end plate, and the second end plate. The method can include providing the second magnet segment. The second magnet segment can include the second pole tip and the second plurality of laminations. The method can include providing the third magnet segment. The third magnet segment can include the third pole tip and the third plurality of laminations. The method can include providing the fourth magnet segment. The fourth magnet segment can include the fourth pole tip and the fourth plurality of laminations.

In some embodiments, the first pole tip distance is defined by the distance between the first pole tip and the third pole tip. The second pole tip distance is defined by the distance between the second pole tip and the fourth pole tip. The absolute value of the difference between the first pole tip distance and the second pole tip distance is less than the threshold value.

In some embodiments, the third pole tip distance is defined by the distance between the first pole tip and the second pole tip. The fourth pole tip distance is defined by the distance between the second pole tip and the third pole tip. The fifth pole tip distance is defined by the distance between the third pole tip and the fourth pole tip. The sixth pole tip distance is defined by the distance between the fourth pole tip and the first pole tip. The average distance is defined by the average of the third pole tip distance, the fourth pole tip distance, the fifth pole tip distance, and the sixth pole tip distance. The maximum distance is defined by the maximum of the third pole tip distance, the fourth pole tip distance, the fifth pole tip distance, and the sixth pole tip distance. The minimum distance is defined by the minimum of the third pole tip distance, the fourth pole tip distance, the fifth pole tip distance, and the sixth pole tip distance. The difference between the maximum distance and the average distance is less than the threshold value. The difference between the average distance and the minimum distance is less than the threshold value.

In some embodiments, the method can include coupling the second magnet segment to the first magnet segment. The method can include coupling the third magnet segment to the second magnet segment. The method can include coupling the fourth magnet segment to the third magnet segment. The method can include coupling the first magnet segment to the fourth magnet segment.

No claim element herein is to be construed under the provisions of 35 U.S.C. § 112(f), unless the element is expressly recited using the phrase “means for.”

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

As used herein, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

As used herein, the terms “about” and “approximately” generally mean plus or minus 10% of the stated value. For example, about 0.5 would include 0.45 and 0.55, about 10 would include 9 to 11, about 1000 would include 900 to 1100.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Although the figures and description may illustrate a specific order of method steps, the order of such steps may differ from what is depicted and described, unless specified differently above. Also, two or more steps may be performed concurrently or with partial concurrence, unless specified differently above.

It is important to note that any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed:

1. An assembly, comprising:
a magnet segment comprising:
a lamination stack comprising a plurality of laminations arranged in a stacked configuration, each of the plurality of laminations comprising:
a first portion of a first end of the lamination, the first portion comprising:
a first arm spring;
a first reference surface positioned a first distance from the first arm spring; and
a first spring clamp base positioned a second distance from the first arm spring and comprising a second reference surface and a third reference surface;
a second portion of the first end of the lamination, the second portion comprising:
a second arm spring;
a fourth reference surface positioned a third distance from the second arm spring; and
a second spring clamp base positioned a fourth distance from the second arm spring and comprising a fifth reference surface and a sixth reference surface; and
a second end of the lamination, wherein the second ends of the plurality of laminations form a pole tip;
a first side plate configured to couple with the first portions of the first ends of the plurality of laminations;
a second side plate configured to couple with the second portion of the first ends of the plurality of laminations;
a first end plate positioned at a first end of the lamination stack; and
a second end plate positioned at a second end of the lamination stack.

2. The assembly of claim 1, wherein each of the plurality of laminations comprises:
a witness mark positioned at the first portion of the first end of the lamination.

3. The assembly of claim 2, wherein:
the plurality of laminations comprises a first set of laminations oriented in a first direction and a second set of laminations oriented in a second direction;
the witness marks of the first set of laminations are positioned on a first side of a line between the first end and the second end; and
the witness marks of the second set of laminations are positioned on a second side of the line between the first end and the second end.

4. The assembly of claim 1, wherein:
the first side plate comprises a first spring clamp stop;
the second side plate comprises a second spring clamp stop; and
for each of the plurality of laminations:
the first spring clamp base is configured to couple with the first spring clamp stop;
a first force applied to the first arm spring causes the lamination to press against the first spring clamp stop at the first reference surface, the second reference surface and the third reference surface;
the second spring clamp base is configured to couple with the second spring clamp stop; and
a second force applied to the second arm spring causes the lamination to press against the second spring clamp stop at the fourth reference surface, the fifth reference surface and the sixth reference surface.

5. The assembly of claim 4, wherein:
a first bolt is configured to apply the first force; and
a second bolt is configured to apply the second force.

6. The assembly of claim 1, wherein the magnet segment is a first magnet segment and the pole tip is a first pole tip, the assembly comprising:
a second magnet segment comprising a second pole tip and a third side plate;
wherein a tapered pin is configured to couple the first side plate with the third side plate.

7. The assembly of claim 1, wherein the magnet segment is a first magnet segment, the pole tip is a first pole tip, and the plurality of laminations is a first plurality of laminations, the assembly comprising:
a second magnet segment comprising a second pole tip and a second plurality of laminations;
a third magnet segment comprising a third pole tip and a third plurality of laminations; and
a fourth magnet segment comprising a fourth pole tip and a fourth plurality of laminations.

8. The assembly of claim 7, wherein:
a first pole tip distance is defined by a distance between the first pole tip and the third pole tip;
a second pole tip distance is defined by a distance between the second pole tip and the fourth pole tip; and
an absolute value of a difference between the first pole tip distance and the second pole tip distance is less than a threshold value.

9. The assembly of claim 7, wherein:
a third pole tip distance is defined by a distance between the first pole tip and the second pole tip;
a fourth pole tip distance is defined by a distance between the second pole tip and the third pole tip;
a fifth pole tip distance is defined by a distance between the third pole tip and the fourth pole tip;
a sixth pole tip distance is defined by a distance between the fourth pole tip and the first pole tip;
an average distance is defined by an average of the third pole tip distance, the fourth pole tip distance, the fifth pole tip distance, and the sixth pole tip distance;
a maximum distance is defined by a maximum of the third pole tip distance, the fourth pole tip distance, the fifth pole tip distance, and the sixth pole tip distance;
a minimum distance is defined by a minimum of the third pole tip distance, the fourth pole tip distance, the fifth pole tip distance, and the sixth pole tip distance;
a difference between the maximum distance and the average distance is less than a threshold value; and
a difference between the average distance and the minimum distance is less than the threshold value.

10. The assembly of claim 7, wherein:
the first plurality of laminations is separated from the second plurality of laminations by a first gap;
the second plurality of laminations is separated from the third plurality of laminations by a second gap;
the third plurality of laminations is separated from the fourth plurality of laminations by a third gap; and
the fourth plurality of laminations is separated from the first plurality of laminations by a fourth gap.

11. The assembly of claim 1, wherein the plurality of laminations comprise laser-cut laminations.

12. The assembly of claim 1, wherein the plurality of laminations comprise stamped laminations.

13. The assembly of claim 1, wherein the plurality of laminations comprise silicon-iron.

14. The assembly of claim 1, wherein:
the first end plate comprises a first recess configured to receive the first side plate; and
the second end plate comprises a second recess configured to receive the second side plate.

15. A method, comprising:
providing a lamination stack comprising a plurality of laminations arranged in a stacked configuration, each of the plurality of laminations comprising:
a first portion of a first end of the lamination, the first portion comprising:
a first arm spring;
a first reference surface positioned a first distance from the first arm spring; and
a first spring clamp base positioned a second distance from the first arm spring and comprising a second reference surface and a third reference surface; and
a second portion of the first end of the lamination, the second portion comprising:
a second arm spring;
a fourth reference surface positioned a third distance from the second arm spring; and
a second spring clamp base positioned a fourth distance from the second arm spring and comprising a fifth reference surface and a sixth reference surface;
wherein a second end of the plurality of laminations form a pole tip;
coupling a first side plate with the first portions of the first ends of the plurality of laminations;
coupling a second side plate with the second portion of the first ends of the plurality of laminations;
coupling a first end plate with a first end of the lamination stack; and
coupling a second end plate with a second end of the lamination stack.

16. The method of claim 15, wherein the plurality of laminations comprises a first plurality of laminations and a second plurality of laminations, the method comprising:
orienting the first plurality of laminations in a first direction; and
orienting the second plurality of laminations in a second direction.

17. The method of claim 15, comprising:
applying, by a first bolt, for each of the plurality of laminations, a first force to the first arm spring to cause the lamination to press against a first spring clamp stop of the first side plate at the first reference surface, the second reference surface and the third reference surface; and
applying, by a second bolt, for each of the plurality of laminations, a second force to the second arm spring to cause the lamination to press against a second spring clamp stop of the second side plate at the fourth reference surface, the fifth reference surface and the sixth reference surface.

18. The method of claim 15, comprising:
providing a first magnet segment comprising the plurality of laminations, the first side plate, the second side plate, the first end plate, and the second end plate;
providing a second magnet segment comprising a second pole tip and a second plurality of laminations;
providing a third magnet segment comprising a third pole tip and a third plurality of laminations; and
providing a fourth magnet segment comprising a fourth pole tip and a fourth plurality of laminations.

19. The method of claim 18, wherein:
the pole tip is a first pole tip;
a first pole tip distance is defined by a distance between the first pole tip and the third pole tip;
a second pole tip distance is defined by a distance between the second pole tip and the fourth pole tip; and
an absolute value of a difference between the first pole tip distance and the second pole tip distance is less than a threshold value.

20. The method of claim 18, comprising:
coupling the second magnet segment to the first magnet segment;
coupling the third magnet segment to the second magnet segment; and
coupling the fourth magnet segment to the first magnet segment.
